(19) United States
(12) Patent Application Publication
(10) Pub. No.: US 2013/0280942 A1
(43) Pub. Date: Oct. 24, 2013

(54) Connector Housing

(71) Applicant: YAZAKI CORPORATION, Tokyo (JP)

(72) Inventor: Takashi Muro, Shizuoka (JP)

(21) Appl. No.: 13/922,597

(22) Filed: Jun. 20, 2013

Related U.S. Application Data
(63) Continuation of application No. PCT/JP2011/079658, filed on Dec. 21, 2011.

(30) Foreign Application Priority Data
Dec. 21, 2010 (JP) 2010-285094

(51) Int. Cl. H01R 13/627

(52) U.S. Cl. CPC H01R 13/627
USPC 439/345

(57) ABSTRACT

A projection 11 of a first connector 10 is defined into three separate engagement pieces 11A, 11B, and 11C by slits S1 and S2, thereby making the engagement piece 11A longer than the other engagement pieces 11B and 11C, and forming a slope 11F with a gentler angle than an angle of the other slopes. Accordingly, force required to insert the engagement piece 11A into a plate 20A that juts in a center of a second connector 20 is lessened. Subsequently, initial force required to insert the other engagement pieces 11B and 11C into the plate 20A is also lessened.

### CROSS REFERENCE TO RELATED APPLICATION

This application is a continuation of PCT application No. PCT/JP2011/079658, which was filed on Dec. 21, 2011 based on Japanese Patent Application (No. 2010-285094) filed on Dec. 21, 2010, the contents of which are incorporated herein by reference. Also, all the references cited herein are incorporated as a whole.

### BACKGROUND OF THE INVENTION

1. Field of the Invention

The present invention relates to a connector housing that holds a counterpart connector housing in a strongly fitted state and, more particularly, to a connector housing that enables insertion of its counter part connector housing with small insertion force and also exhibits strong holding power.

2. Description of the Related Art

<Connector Engagement Structure Described in Connection with JP-A-2008-97956>

In order to fit connector housings to each other and hold them in a fitted state, it has hitherto been known to use an engagement structure that has an engagement hole formed in one connector housing and that has an engagement projection formed on the other connector housing (see JP-A-2008-97956).

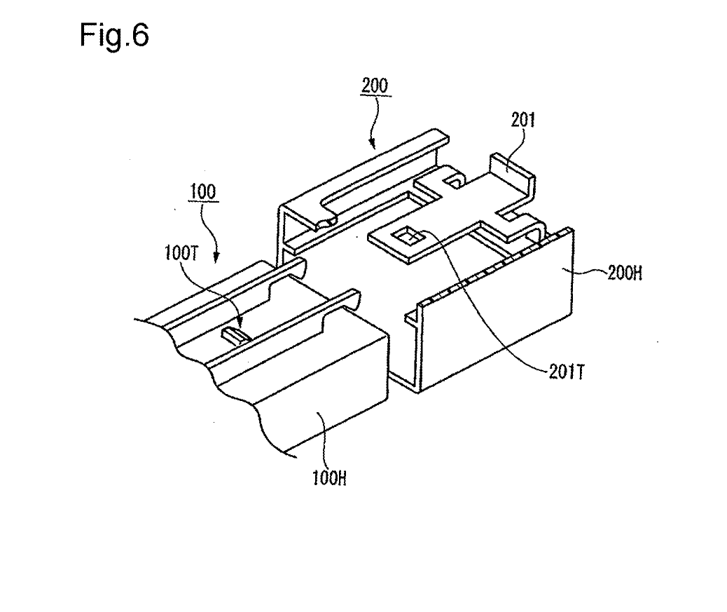

FIG. 6 shows a connector engagement structure described in connection with JP-A-2008-97956.

In FIG. 6, when a first connector 200 and a second connector 100 are fitted together, a connector housing 100H of the second connector 100 is inserted into a connector housing 200H of the first connector 200, whereupon a lock arm 201 is lifted, and an engagement protuberance 100T comes into engagement with an engagement hole 201T, thereby holding the connectors in a fitted state.

<Problem in the Connector Engagement Structure Described in Connection with JP-A-2008-97956>

Holding force of the connector engagement structure described in connection with JP-A-2008-97956 is dependent on a contact area (a shear area) defined by a width and a height of a contact between the engagement hole 201T and the engagement protuberance 100T. Specifically, the holding force increases with an increase in contact area. However, the lock arm 201 becomes thicker correspondingly. Reaction force of the lock arm 201 that is raised in the course of fitting the connectors is enhanced, which in turn raises a problem of deterioration of workability.

### SUMMARY OF THE INVENTION

The present invention is conceived in light of the circumstance and aims at providing a connector housing that lessens inserting force of the connectors during connector-fitting work and that keeps strong holding force acquired after fitting.

The objective is accomplished by configurations described in (1) to (4).

(1) A connector housing with a projection that has engagement projections to engage with an engagement hole of a counterpart connector housing and that extends in a connector-fitting direction, the connector housing comprising: a plurality of engagement pieces that are defined separately from each other by making slits from an extremity of the projection up to an arbitrary position along the connector-fitting direction and that are elastically deformed; slopes formed in lower portions of the respective engagement pieces that oppose the engagement hole; and lock surfaces of the respective engagement projections formed at rear ends of the respective slopes, wherein an angle of the slope of one engagement piece is made smaller than an angle of the slopes of the other engagement pieces.

(2) In the connector housing described in connection with (1), the slits formed between the engagement pieces are formed so that the slits formed between the engagement pieces are formed so that length of the slits is from extremity of the engagement pieces to a front of a shear angle formed at a base of the engagement projection.

(3) In the connector housing described in connection with (1) or (2), a first center engagement piece of the engagement pieces is made projectingly longer than the other engagement pieces, and an angle of a slope of the first engagement piece is made smaller than an angle of slopes of the other engagement pieces.

(4) In the connector housing described in connection with (3), a second engagement piece and a third engagement piece are positioned on both sides of the first engagement piece, and the second engagement piece differs from the third engagement piece in terms of a projection length and a slope angle.

By means of the configuration described in connection with (1), the engagement pieces are separated from each other by the slits, and an angle of the slope of one engagement piece is differ from an angle of the slopes of the other engagement pieces. As a result, insertion force required during fitting work is dispersed between the engagement pieces, so that the insertion force is lessened. Therefore, the connector is smoothly fitted to the counterpart connector housing. The lock surfaces of all the engagement projections and the lock side surface of the engagement hole contact each other, and a sufficient contact area is assured. Accordingly, firm engagement is achieved.

By means of the configuration described in connection with (2), an extent of trenches of the slits formed between the engagement pieces is limited, whereby a firm connector engagement structure can be assured without affecting a shear angle.

By means of the configuration described in connection with (3), when the connector is fitted to the counterpart connector housing, the slope of the first engagement piece first contacts the tapered area of the counterpart connector housing. The gentle angle of the slope fits well with the slope of the tapered area, and stable low insertion force can be achieved in cooperation with dispersion of the insertion force affected by the first engagement piece.

By means of the configuration described in connection with (4), after the first engagement piece contacts the tapered area of the counterpart connector housing, the second engagement piece (or the third engagement piece) and the third engagement piece (or the second engagement piece) contacts, in this sequence, the tapered area of the counterpart connector housing. Hence, the insertion force required during insertion is dispersed and lessened, whereby the connector is smoothly fitted to the counterpart connector housing by low insertion force.

### BRIEF DESCRIPTION OF THE PREFERRED EMBODIMENTS

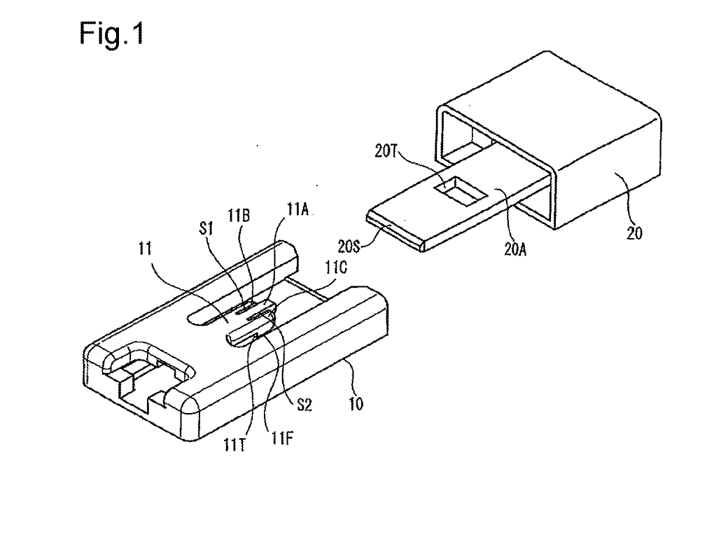

FIG. 1 is a perspective view of a first embodiment of a connector housing equipped with a connector engagement structure of one implementation mode of the present invention.

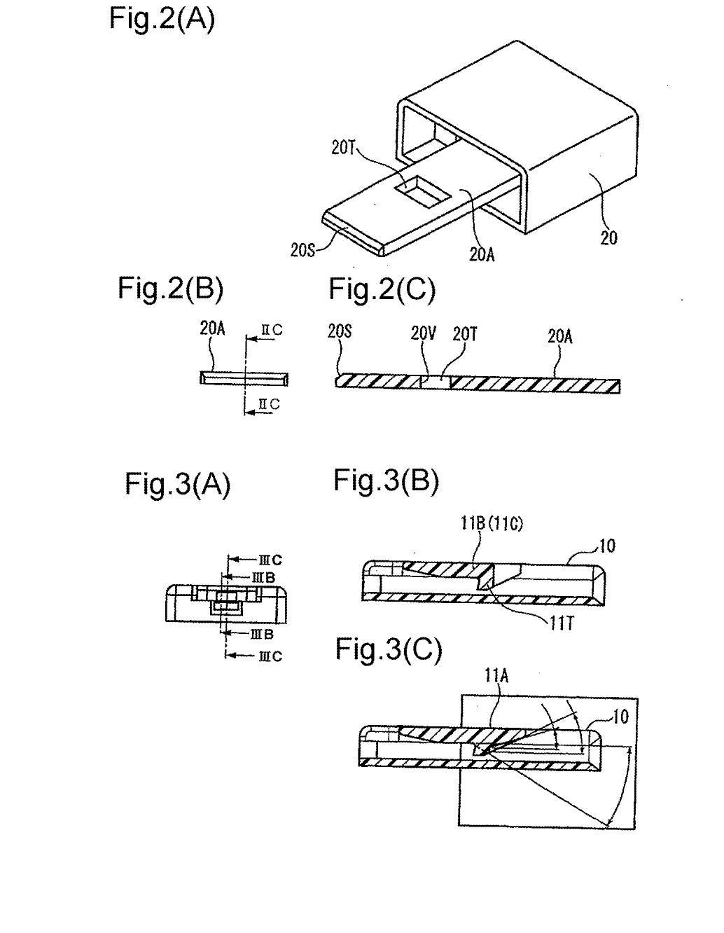

FIG. 2(A) to 2(C) show the implementation mode of a counterpart connector housing shown in FIG. 1, wherein FIG. 2(A) is an overall perspective view, FIG. 2(B) is a front view showing only a plate of the counterpart connector housing, and FIG. 2(C) is a cross sectional view taken along line IIC-IIC shown in FIG. 2(B).

FIG. 3(A) to FIG. 3(C) show the connector housing shown in FIG. 1, wherein FIG. 3(A) is a front view, FIG. 3(B) is a cross sectional view taken along line IIIB-IIIB shown in FIG. 3(A), and FIG. 3(C) is a cross sectional view taken along line IIIC-IIIC shown in FIG. 3(A).

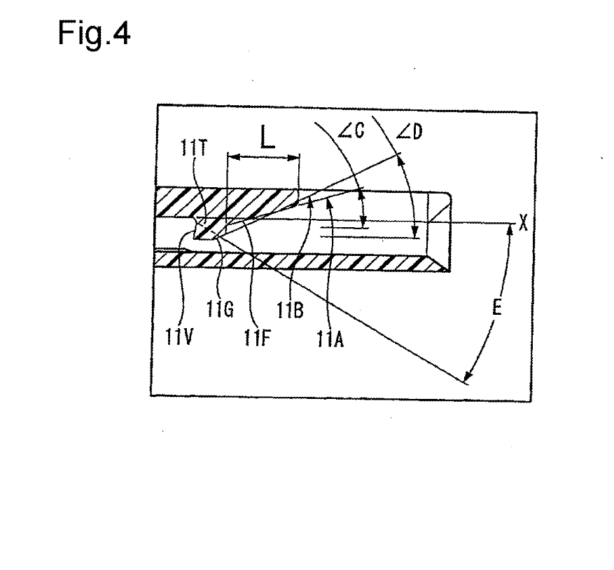

FIG. 4 is an enlarged view of an area enclosed by a square shape shown in FIG. 3(C).

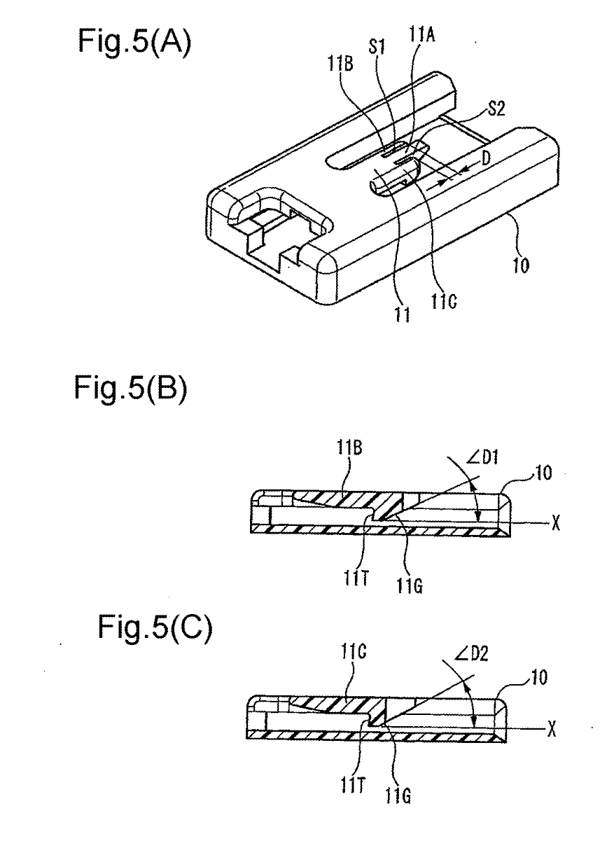

FIG. 5(A) is a perspective view of a second embodiment of the connector housing equipped with the connector engagement structure of the implementation mode of the present invention, wherein FIG. 5(B) is a cross sectional view of a second engagement piece shown in FIG. 5(A), and FIG. 5(C) is a cross sectional view of a third engagement piece shown in FIG. 5(A); and

FIG. 6 is a perspective view showing a known, related-art connector engagement structure.

### DESCRIPTION OF THE PREFERRED EMBODIMENTS

A best mode for implementing the present invention is now described by reference to the drawings.

### First Embodiment

### <Detailed Descriptions of a First Connector: See FIG. 1>

A first connector (connector housing) 10 that is a first embodiment of a connector engagement structure pertinent to one implementation mode of the present invention shown in FIG. 1 is molded from a resin, substantially assuming a shape of a rectangular parallelepiped.

A projection 11 that projects toward an extremity (a right direction in FIG. 1) of the first connector 10 is formed in a center area of the first connector 10 so as to extend in a connector-fitting direction along which the connector is to be fit. A plurality of engagement pieces; namely, a first engagement piece 11A, a second engagement piece 11B, and a third engagement piece 11C are provided in a vicinity of the extremity of the projection 11. Slits S1 and S2 are provided between the engagement pieces 11A, 11B, and 11C along the connector-fitting direction.

The first engagement piece 11A is situated at the center, and an extremity of the first engagement piece 11A juts to a greater projection length along the connector-fitting direction (a rightward in FIG. 1) than a projection length of the second engagement piece 11B and the third engagement piece 11C.

### <Detailed Descriptions of a Second Connector: See FIG. 2(A) to FIG. 2(C)>

A second connector (a counterpart connector housing) 20 shown in FIG. 2(A) to 2(C), which is the implementation mode of the present invention, is molded from a resin, or the like, in a shape of a substantially rectangular parallelepiped.

A jutting (in a leftward direction in FIG. 2(A)) plate 20A is formed in a center of the connector. A substantially rectangular engagement hole 20T and a lock side surface 20V are formed in the plate 20A, and a tapered area 20S that has an inclination toward an interior of the second connector 20 is formed at an extremity of the plate 20A.

### <Detailed Descriptions of the Projection of the First Connector: See FIG. 3(A) to FIG. 3(C)>

The projection 11 of the first connector 10 is now described in detail by reference to FIG. 3(A) to FIG. 3(C).

An engagement projection 11T is formed on each of the engagement pieces 11A, 11B, and 11C. The engagement projections 11T are intended for engagement with the engagement hole 20T opened in the second connector 20.

The extremity of the second engagement piece 11B and the extremity of the third engagement piece 11C are formed to a projection length that is shorter than the projection length of the first engagement piece 11A and cut in a substantially vertical direction (see FIG. 3(B)).

In the meantime, a lower portion of the first engagement piece 11A is tapered from its extremity toward the engagement projection 11T (see FIG. 3(C)).

### <Detailed Descriptions of the Vicinity of the Extremities of the Respective Engagement Pieces: See FIG. 4>

A detailed shape of each of the vicinities of the extremities of the respective engagement pieces 11A, 11B, and 11Cc are now described by reference to FIG. 4.

The engagement projection 11T is formed on a lower portion of each of the engagement pieces 11A, 11B, and 11C that oppose the engagement hole 20T. A lock surface 11V that contacts the lock side surface 20V formed on the engagement hole 20T of the second connector 20 is formed on each of the engagement projections 11T.

A slope 11F that has a downward inclination (a downward direction in FIG. 4) from its extremity toward the engagement projection 11T is formed on a lower portion of the first engagement piece 11A. A slope 11G is formed on an underside of the engagement projection 11T of the second engagement piece 11B (and the third engagement piece 11C).

An angle of the slope 11F and an angle of the slope 11G are now described in detail.

An angle which a horizontal plane X of the first connector 10 forms with the slope 11F of the first engagement piece 11A is taken as C (∠C), and an angle which the slope 11G of the second engagement pieced 11B (and the third engagement pieced 11C) with the horizontal plane X is taken as D (∠D), the angle ∠C is made smaller than ∠D (∠C<∠D). Specifically, a rise angle of the slope 11F is gentler than a rise angle of the slope 11G.

In the meantime, a trench depth (a slit length L) of each of the slits S1 and S2 formed between the engagement pieces 11A, 11B, and 11C is one that does not affect an area of a contact (i.e., a shear area) between the lock surface 11V of the engagement projection 11T and the lock side surface 20V of the engagement hole 20T.

Specifically, the trenches of the slits S1 and S2 are formed such that the trenches do not interfere with a shear angle E which an imaginary extension from the extremity of the second engagement piece 11B or the third engagement piece 11C forms with a base of the engagement projection 11T.

Put another word, the lock surfaces 11V of the respective engagement pieces 11A, 11B, and 11C are continuous, and the lock surfaces 11V form a plane in which the slits S1 and S2 are not made.

### <Engagement Relationship>

The connector engagement structure of the implementation mode of the present invention is as noted above. Next, an engagement relationship between the respective engagement pieces 11A, 11B, and 11C and the engagement hole 20T is described.

When the first connector 10 is inserted into the second connector 20, the first engagement piece 11A juts out of the other engagement pieces 11B and 11C. Therefore, the slope 11F of the first engagement piece 11A first contacts the tapered area 20S of the plate 20A.

Next, the first engagement piece 11A separated from the slits S1 and S2 on both sides of the first engagement piece 11A slides over the plate 20A, thereby coming into a press-contact with the plate 20A. Therefore, the first engagement piece 11A first undergoes upward resilient deformation. On this occasion, since the angle of the slope 11F of the first engagement piece 11A is gentle, only slight insertion force is required. Specifically, when the first connector 10 is inserted into the second connector 20, two elements are present.

The first element is a load that develops when the slope 11F is joined to the tapered area 20S.

Both the slope 11F and the tapered area 20S are inclined planes. A juncture between the inclination of the gently-angled slope 11F and the inclination of the tapered area 20S makes elastic deformation of the first engagement piece 11A easy.

The second element is elastic deformation force that is exerted on the first engagement piece 11A.

The three engagement pieces 11A, 11B, and 11C are separated from each other by means of the slits S1 and S2. Since a width of the first engagement piece 11A is about one-third of a width of the projection 11, the first engagement piece 11A entails only one-third of the force required to elastically deform the entire projection 11, elastic deformation of the first engagement piece 11A is facilitated.

Since the foregoing two elements work in a cooperative manner when the first connector 10 and the second connector 20 are fitted together, insertion force is significantly lessened, and hence fitting work can be smoothly performed.

When the first connector 10 is inserted further into the second connector 20, the second engagement piece 11B and the third engagement piece 11C slide, in an interlocking manner, over the plate 20A, to thus come into a press-contact with the plate 20A. Hence, the second engagement piece 11B and the third engagement piece 11 C are elastically deformed in an upward direction.

When the engagement projection 11T is engaged with the engagement hole 20T, the respective engagement pieces 11A, 11B, and 11C restore themselves to their original positions from the elastically deformed positions. The lock surfaces 11V of the engagement projections 11T come into contact with the lock side surface 20V of the engagement hole 20T. The first connector 10 and the second connector 20 have finished fitting to each other, whereupon the first connector 10 and the second connector 20 hold a fitted state.

Holding force resultant from a state in which the first connector 10 and the second connector 20 are fitted together is now explained.

Since the trenches of the slits 51 and S2 of the first connector 10 are formed up to a point where they do not affect the contact area between the lock surfaces 11V and the lock side surface 20V; namely, a point where the trenches do not cross the shear angle E or a point short of the shear angle E, the width of the lock surfaces 11V and the width of the lock side surface 20V are equal to each other, and a contact area between the lock surfaces 11V and the lock side surface 20V is reliably assured, so that the fit hold force becomes firm.

### Second Embodiment

FIG. 5(A) to FIG. 5(C) show a second embodiment of the first connector 10 equipped with the connector engagement structure of the implementation mode of the present invention.

The extremity of the first engagement piece 11A juts (a rightward direction in FIG. 5(A)) in excess of the second engagement piece 11B and the third engagement piece 11c as in the case with the first embodiment. However, a projection length of the second engagement piece 11B differs from a projection length of the third engagement piece 11C. Specifically, in the second embodiment, an extremity of the second engagement piece 11B juts in excess of an extremity of the third engagement piece 11C. A difference between the projection lengths is designated by reference symbol D in FIG. 5(A).

The slope 11G is now described by reference to FIG. 5(B) and FIG. 5(C).

An angle D1 (see FIG. 5(B)) which the slope 11B made on the second engagement piece 11B forms with the horizontal plane X is made smaller (∠D1<∠D2) than an angle D2 (see FIG. 5(C)) which the slope 11G made on the third engagement piece 110 forms with the horizontal plane X.

In relation to the engagement relationship, it has been described that, since the angle (∠C) of the slope 11F of the first engagement piece 11A is gentle, only slight insertion force is required when the first connector 10 is fitted to the second connector 20.

Further, in succession to the slope 11F of the first engagement piece 11A, the slope 11G of the second engagement piece 11B contacts the tapered area 20S of the plate 20A in the second embodiment, sliding over the plate 20A and coming into press-contact with the plate 20, so that the second engagement piece 11B is elastically deformed in an upward direction.

Accordingly, the insertion force required during fitting work is lessened by dispersion of the insertion force when compared with the force required in the first embodiment.

Specifically, when the first connector 10 is fitted to the second connector 20, the three engagement pieces 11A, 11B, and 11C contact, in this sequence, the tapered area 20S and slide over the plate 20A while dispersing insertion force. Accordingly, fitting the first connector 10 to the second connector 20 is implemented extremely smoothly by light force.

It has been described that the second engagement piece 11B juts in excess of the third engagement piece 11C and that the angle of the slope 11G is gentle. However, even if the third engagement piece 11C juts in excess of the second engagement piece 11B and if the angle of the slope 11G is much gentler, the working effect of the present invention still remains unchanged.

### <Summary of the Implementation Mode>

In the connector engagement structure of the implementation mode of the embodiment of the present invention described above, the first connector 10 with the projection 11 that includes the plurality of engagement pieces 11A, 11B, and 11C each of which has on its lower portion the engagement projection 11T and the lock surface 11V and the second connector 20 having the engagement hole 20T opened in the lock side surface 20V are fitted together, whereupon the engagement projection 11T and the engagement hole 20T are engaged with each other, to thus maintain a fitted state.

The fitted state can be maintained by means of a foregoing comparatively simple configuration.

Since the engagement pieces 11A, 11B, and 11C are separated from each other by means of the slits S1 and S2, which allows independent motion of each of the engagement pieces during fitting work, workability is enhanced by a reduction in insertion force.

Further, easy removal of the first connector 10 and the second connector 20, which would otherwise arise after fitting, is reliably prevented by means of a contact between the lock surface 11V and the lock side surface 20V.

In the connector engagement structure of the implementation mode of the present invention, the trenches of the slits S1 and S2 existing between the engagement pieces 11A, 11B, and 11C are made to a point short of the shear angle E which the extremity of the second engagement piece 11B forms with the base of the engagement projection 11T.

There is provided a strong connector engagement structure in which the contact area between the lock surface 11V and the lock side surface 20V is not affected by limiting an extent of the trenches of the slits S1 and S2.

Further, in the first embodiment of the connector engagement structure of the implementation mode of the present invention, the slope 11F whose angle is smaller than the angle of the slopes 11G of the other engagement pieces 11B and 11C is formed on the lower portion of the first engagement piece 11A that is formed so as to jut in excess of the other engagement pieces 11B and 11C. A tapered area is provided on the extremity of the plate 20A of the second connector 20.

When the first connector 10 and the second connector 20 are fitted to each other, the slope 11F of the first engagement piece 11A first contacts the tapered area 20S. On this occasion, the gentle angle of the slope 11F and the slope of the tapered area 20S fit in well with each other, which enables load-free smooth insertion of the connector in cooperation with dispersion of the insertion force affected by the first engagement piece 11A.

In the second embodiment of the connector engagement structure of the implementation mode of the present invention, the second engagement piece 11B and the third engagement piece 11C differ from each other in terms of a projection length and the angle of the slope 11G.

After the first engagement piece 11A contacts the plate 20A, the second engagement piece 11B and the third engagement piece 11C contact, in this sequence, the plate 20A. Therefore, the insertion force required during inserting work is dispersed and lessened to a much greater extent, whereby the first connector 10 and the second connector 20 are smoothly fitted to each other.

Even the second embodiment yields the same working effect as that yielded in the implementation mode of the present invention.

In the above-described implementation mode of the present invention, the projection 11 with the respective engagement pieces 11A, 11B, and 11C is provided on the first connector 10. The plate 20A with the engagement hole 20T is provided on the second connector 20. A layout relationship between them can also be reversed.

The present invention is not limited to the implementation mode and susceptible to variations, modifications, and the like, as required. In addition, so long as the present invention can be accomplished, the respective constituent elements described in connection with the implementation mode are arbitrary and nonrestrictive in terms of a material, a shape, a size, a numeric, a mode, a number, a location, and others.

The connector housing of the present invention can lessen the force required to insert a connector during work for fitting the connectors together and make strong holding force achieved after fitting.

What is claimed is:

1. A connector housing, comprising:
a projection that has an engagement projection to engage with an engagement hole of a counterpart connector housing and that extends in a connector-fitting direction;
a plurality of engagement pieces defined by making slits from an extremity of the projection up to an arbitrary position of the projection along the connector-fitting direction and elastically deformed;
slopes formed in lower portions of the respective engagement pieces that oppose the engagement hole; and
lock surfaces of the respective engagement projections formed at rear ends of the respective slopes;
wherein an angle of the slope of one engagement piece is made smaller than an angle of the slopes of the other engagement pieces.

2. The connector housing according to claim 1, wherein the slits formed between the engagement pieces are formed so that length of the slits is from extremity of the engagement pieces to a front of a shear angle formed at a base of the engagement projection.

3. The connector housing according to claim 1, wherein a first center engagement piece of the engagement pieces is made projectingly longer than the other engagement pieces, and an angle of a slope of the first engagement piece is made smaller than an angle of slopes of the other engagement pieces.

4. The connector housing according to claim 3, wherein a second engagement piece and a third engagement piece are positioned on both sides of the first engagement piece, and the second engagement piece differs from the third engagement piece in terms of a projection length and a slope angle.
